(19) United States
(12) Patent Application Publication
(10) Pub. No.: US 2011/0092659 A1
(43) Pub. Date: Apr. 21, 2011

(54) Improved Method For Making Tinted Polymers

(75) Inventors: Peter McKenna, Essex (GB); Michael Brett Graham, Hampshire (GB); Melissa Matthews, Hampshire (GB)

(73) Assignee: COGNIS IP MANAGEMENT GMBH, Duesseldorf (DE)

(21) Appl. No.: 12/678,022

(22) PCT Filed: Sep. 6, 2008
(86) PCT No.: PCT/EP08/07296

§ 371 Date: Nov. 23, 2010

(30) Foreign Application Priority Data
Sep. 13, 2007 (GB) 0717877.5

(51) Int. Cl. C08F 212/32; C08F 226/10; C08F 220/28; C08F 220/34; C08F 222/20; C08F 212/14

(52) U.S. Cl. 526/264; 526/280

(57) ABSTRACT

A process for the production of a tinted polymer, which comprises co-polymerising a compound of the general formula I or a salt thereof with a polymerisable monomer containing a vinyl group, formula I being:

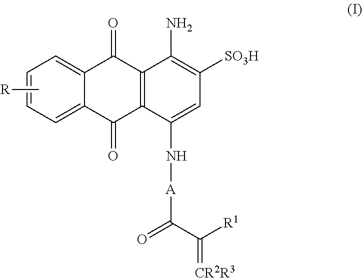

in which R represents a hydrogen atom or an —SO₃H group; A represents a direct bond, -alkylene-O—, or a -phenylene-NH— or -phenylene-NH-phenylene-NH— group in which the or each phenylene ring may be optionally substituted by one or more of the same or different groups selected from —SO₃H, —(CH₂)ₘSO₃H, —SO₂(CH₂)ₘSO₃H, —SO₂NH(CH₂)ₘSO₃H, —SO₂C₁₋₂alkyl, —SO₂C₁₋₂haloalkyl, —SO₂NHC₁₋₂alkyl, —SO₂NHC₁₋₂haloakyl, —C₁₋₂alkyl, or C₁₋₂haloalkyl, in which m represents 1 or 2; R¹ represents a hydrogen or halogen atom or a C₁₋₄ alkyl group; and each of R² and R³, which may be the same or different, represents a hydrogen atom or a C₁₋₄ alkyl or alkoxy group; with the proviso that, if R¹ represents a hydrogen or a C₁₋₄alkyl group and simultaneously R represents a hydrogen atom, A must represent a -phenylene-NH— or -phenylene-NH-phenylene-NH- group in which at least one phenylene ring is substituted by at least one sulfur-containing group.

The present invention relates to an improved method of making tinted polymeric materials, particularly those suitable for use in medical devices, particularly contact lenses.

Contact lenses have been used to improve vision for many years. It is sometimes desired to impart a coloured tint to these lenses, and a number of methods for doing this have been described. An early technology for tint lenses was based on the incorporation of pigment by the suspension of colloid pigment in the monomer prior to it polymerisation. Examples of such pigment are C.I. Pigment blue 15, C.I Pigment Violet 23, C.I Pigment Blue 36, C.I Vat orange 1, C.I. Vat brown 1, C.I. Vat yellow 3 C.I. Vat Blue 6, and C.I. vat Green 1. The disadvantage of the pigments was the difficult to achieve small enough particles so that the pigment was not seen and homogeneous, and the stability of the colloid which had limited self life.

One current conventional method is to prepare the lens, and then to apply a solution of a dye to the lens, and bond the dye to the polymer which forms the lens. One example of such a method is described in U.S. Pat. No. 4,553,975. Here, pre-formed contact lenses made of a polymeric lens material are reacted with a reactive dyestuff in such a way that the dye becomes bonded external to the polymer backbone to hydroxyl, amino, amido or mercapto groups present in the polymer.

Alternatively, according to U.S. Pat. No. 4,553,975, a monomer such as HEMA can be reacted with reactive dyestuff prior to polymerization. Again, the dye reacts with the hydroxy group of the HEMA; any monomer used in the process must contain at least one functional group capable of reacting with a reactive dyestuff. Examples of such functional groups are hydroxyl, amino, amide and thio groups. The reactive dye must be one capable of forming an ether-type linkage.

A specific process of this latter type is described in EP 0 595 575, which describes a method for imparting a tint to a soft contact lens, comprising reacting a halotriazine dye with a hydrophilic monomer prior to polymerization to produce a dye-monomer product, which is then polymerized with further monomer to produce a polymer. Here, in the initial reaction step, the dye reacts with the hydroxy group of a monomer such as HEMA, and the resulting monomer, which still contains the vinyl group originating with the HEMA, is co-polymerised via that vinyl group with further HEMA to produce the polymer. A similar process is described in JP 08 327954, where an alkali solution is used to bond a dye to a monomer prior to polymerisation.

Attempts have been made to incorporate the dye into the lens by polymerizing the hydrophilic monomer in the presence of the dye. For example, U.S. Pat. No. 5,151,106 describes a method which incorporates a reactive dye into the polymer during formation of the polymer, during which method the reactive dye is physically entrained within the polymer. Following polymerisation, the product is treated with a base to bond the dye to the polymer.

An alternative approach is taken in U.S. Pat. No. 5,055,602, which discloses a difunctional anthraquinone monomer in which the two amino groups in an anthraquinone dye have been functionalised to contain a polymerizable, unsaturated organic radical. Such compounds, typified by 1,4-bis(4-(2-methacryloxyethyl)phenylamino)anthraquinone, can then be copolymerized with other monomers to produce polymers in which the anthraquinone moiety is cross-linked into the polymer.

An old document, GB 1,400,892 describes a method of making a contact lens, which comprises copolymerising at least one methacrylic ester with a defined reactive dyestuff.

It has now been found that a useful product can be obtained by use of a very specific type of monofunctional dye which can be co-polymerised with suitable monomers. The invention is particularly suitable for use in the preparation of polymers suitable for use in contact lenses and other medical devices.

Accordingly, the present invention provides a process for the production of a tinted polymer, which comprises co-polymerising a compound of the general formula I or a salt thereof with a polymerisable monomer containing a vinyl group, formula I being:

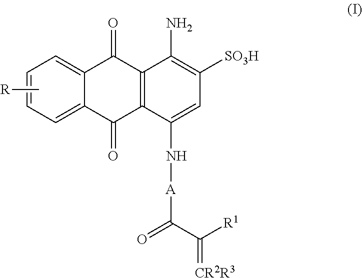

in which R represents a hydrogen atom or an —SO₃H group; A represents a direct bond, -alkylene-O—, or a -phenylene-NH— or -phenylene-NH-phenylene-NH— group in which the or each phenylene ring may be optionally substituted by one or more of the same or different groups selected from —SO₃H, —(CH₂)ₘSO₃H, —SO₂ (CH₂)ₘSO₃H, —SO₂NH(CH₂)ₘSO₃H, —SO₂C₁₋₂alkyl, —SO₂C₁₋₂haloalkyl, —SO₂NHC₁₋₂alkyl, —SO₂NHC₁₋₂haloakyl, —C₁₋₂alkyl, or C₁₋₂haloalkyl, in which m represents 1 or 2; R² represents a hydrogen or halogen (especially bromine) atom or a C₁₋₄ alkyl group; and each of R² and R³, which may be the same or different, represents a hydrogen atom or a C₁₋₄ alkyl or alkoxy group; with the proviso that, if R² represents a hydrogen or a C₁₋₄alkyl group and simultaneously R represents a hydrogen atom, A must represent a -phenylene-NH— or -phenylene-NH-phenylene-NH— group in which at least one phenylene ring is substituted by at least one sulfur-containing group.

Preferably the compound of the formula (I) is used in the form of a salt, especially an alkali metal salt, e.g. a sodium salt.

Preferably, A represents -alkylene-O—, in which the alkylene moiety may for example have up to 4 carbon atoms, for example ethylene-O—; an optionally substituted -phenylene-NH-phenylene-NH— group; or, especially, an optionally-substituted -phenylene-NH— group, for example an optionally substituted 3- or 4-phenylene-NH— group. In a preferred embodiment of the invention, said group A contains at least one sulfur-containing substituent, for example an —SO₃H group. For example, said group A may contain one or two, preferably one, sulfur-containing group, especially an —SO₃H group, optionally together with one or more, for example one or two, C₁₋₂alkyl groups, for example methyl groups. Any halogen atom present in a group A is preferably a chlorine atom.

One preferred sub-group of compounds of formula (I) has the following formula:

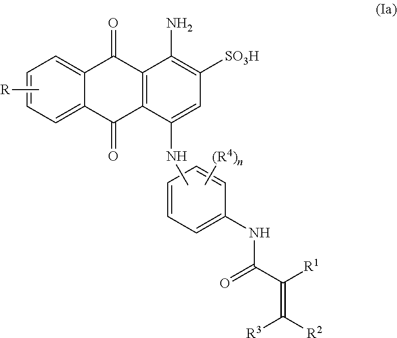

in which R⁴ represents an —SO₃H group and n represents 0, 1 or 2, preferably 0 or 1, especially 1, and the other substituents have the meanings given for the general formula (I). In the formulae (I) or (Ia), R⁴ preferably represents a hydrogen atom, a bromine atom or a methyl group; and preferably each of R² and R³ independently represents a hydrogen atom or a methyl group, especially a hydrogen atom. Preferably, whatever the nature of the other groups present in the molecule, the compounds of formulae I or Ia contain at least two sulfur-containing groups. When R is an —SO₃H group, this may be in any position on the anthraquinone moiety, for example in the 5, 6 or 8 position, preferably in the 6 position.

A further preferred sub-group comprises compounds of the formulae I or Ia in which R⁴ represents a halogen, especially bromine, atom.

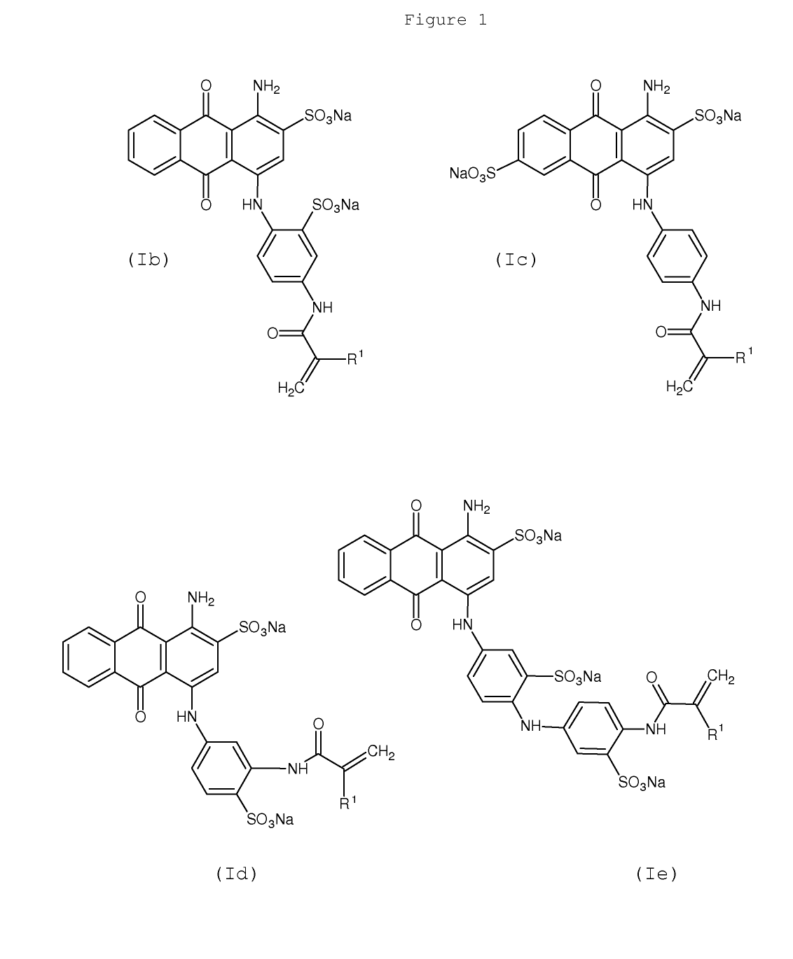

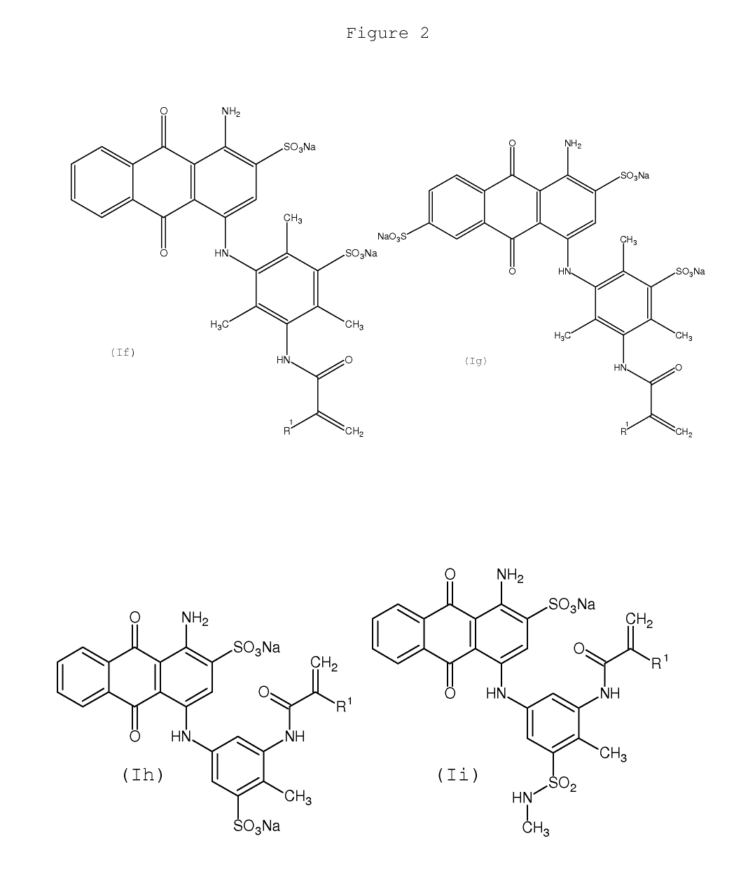

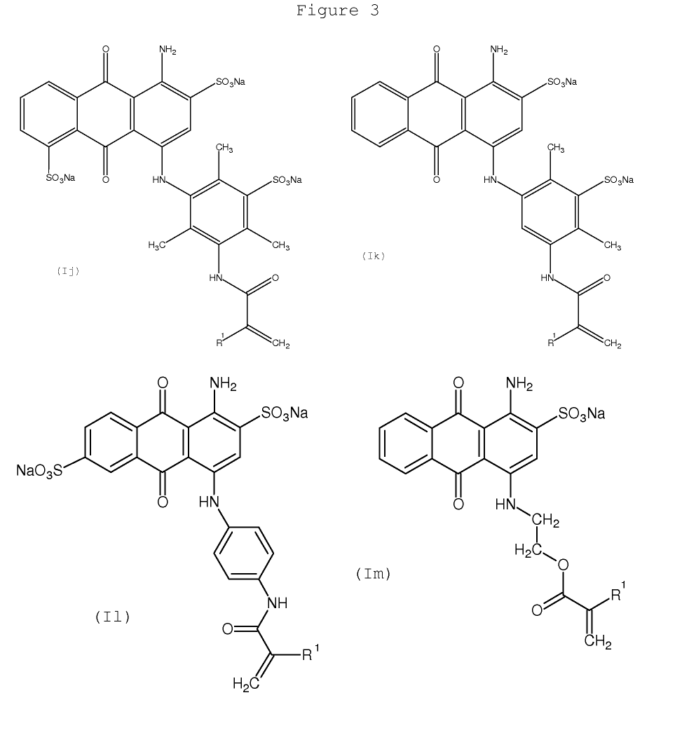

FIGS. 1, 2 and 3 illustrate further preferred sub-groups of compounds of the general formula I, shown in the figures in the sodium salt form, and referred to as formulae (Ib) to (Im). In all cases, R¹ in the formulae shown in the Figures may represent hydrogen, halogen, especially bromine, or C₁₋₄alkyl, especially methyl. Where R¹ in formula (Ib) is bromine, the compound is the commercially-available dye Reactive Blue 69. Where R¹ in formula (Ic) is H, the dye is reddish blue. Where R¹ in formula (Id) is hydrogen, the dye is greenish blue. Where R¹ in formula (Ie) is hydrogen, the dye is blue green.

In the present invention, no step of fixing the dye to a hydroxy group of the polymer (as in U.S. Pat. No. 4,553,975) is required, neither is any preliminary step of reacting a dyestuff with the hydroxy group of the monomer used to prepare the polymer (as in EP 595 575) required. Because the dye is incorporated into the polymer backbone, no leaching of the dye from the polymer can occur after formation.

The polymers prepared according to the present invention are novel, and the invention therefore also provides a polymer which contains as part of its backbone, units derived from a compound of the general formula (I) as defined above together with units derived from at least one other polymerisable vinyl-group containing monomer.

Preferably, the polymer prepared by the process of the invention is one suitable for use in medical devices, for example catheters, implants, stents, intraocular lenses and contact lenses, especially contact lenses, and more especially contact lenses, especially soft contact lenses. It is an advantage of the present invention that, once removed from the mold in which they are made, soft contact lenses prepared in accordance with the invention are hydrated and ready for use. No polishing is required (contrasting with p. 3 lines 8 to 10 of GB 1,400,982, “ . . . the methacrylic polymer copolymerised with a reactive dyestuff is molded and polished to give the desired colored lens”).

Soft contact lenses are gel-like lenses derived from the polymerisation of hydrophilic monomers. Suitable hydrophilic monomers include, for example, hydroxy esters of acrylic, methacrylic, itaconic, fumaric and maleic acid, N,N-dimethylacrylamide (DMA), N-vinyl pyrrolidone (NVP), and styrene sulfonic acid.

Preferably, the hydrophilic monomer is a hydroxy ester of acrylic or methacrylic acid, for example hydroxyethylmethacrylate (HEMA) or hydroxyethylacrylate (HEA), glycerylmethacrylate, hydroxypropylmethacrylate, hydroxypropylacrylate and hydroxytrimethyleneacrylate. HEMA is the most preferred hydrophilic monomer.

The hydrophilic monomer may if desired be copolymerized with any suitable comonomer, for example a hydrophobic comonomer, to achieve desired properties. For example, acrylic and methacrylic acids, alkyl and cycloalkyl acrylates and methacrylates, N-(1,1-dimethyl-3-oxobutyl)acrylamide, and heterocyclic N-vinyl compounds containing a carbonyl group adjacent to the nitrogen in the ring, for example N-vinyl pyrrolidone, may all be used along with hydrophilic monomers. Thus, the equilibrium water content of the lens can be increased if methacrylic acid (MAA) is used as comonomer. Additionally, polyfunctional crosslinking monomers, such as ethylene glycol dimethacrylate (EGDMA) and trimethylolpropane trimethaccrylate (TMPTMA) can be used in small amounts to improve the dimensional stability of the lens. Further, cross-linking agents may be used to improve the polymer properties. Examples of common cross-linking agents include, for example, trimethylolpropane trimethacrylate, ethylene glycol dimethacrylate (EDMA), diethylene glycol dimethacrylate, triethylene glycol dimethacrylate, and diethylene glycol bis-allyl carbonate.

The process of the invention may also be used to prepare tinted contact lenses based on silicone hydrogels. Information on such hydrogels may be found for example in U.S. Pat. No. 4,139,513, U.S. Pat. No. 4,711,943, U.S. Pat. No. 5,070,215, U.S. Pat. No. 5,610,252, U.S. Pat. No. 6,867,425, U.S. Pat. No. 6,020,445, U.S. Pat. No. 5,998,498 and U.S. Pat. No. 6,822,016.

Further, the process of the invention may be used to prepare tinted hard contact lenses. A suitable monomer for making hard contact lenses is methyl methacrylate, cellulose acetate butyrate (CAB), alkyl methacrylate, siloxanyl methacrylate, polysiloxane methacrylatae, and fluoroalkyl methacrylate.

For applications other than contact lenses, the process of the invention may be carried out using any desired vinyl-containing monomer.

In all aspects of the present invention, as well as the dye and the monomer, the reaction mixture may also include an initiator for the polymerisation reaction, preferably in an amount of from about 0.05 to 1%. Typical examples of initiators include lauroyl peroxide, benzoyl peroxide, isopropyl percarbonate, azobisisobutyronitrile, benzoin and its esters, and redox systems such as ammonium persulfate/sodium metabisulfite. Alternatively or in addition, the polymerisation reaction may be initiated by exposure to ionising or actinic radiation, for example UV light, visible light, X-rays, electron beam, or a radioactive source.

The polymerisation may be carried out with or without the presence of a solvent or diluent, as is known in the art. For use in the preparation of polymers for use in medical devices, biocompatible solvents or diluents, for example polyethylene glycols, glycerol, propylene glycol, dipropylene glycol, water, and mixtures thereof, may be used.

Suitable polymerisation conditions are well known to the skilled man. In the present case, it is important that the conditions are such that the dye copolymerises with the monomer, and does not react with, for example, a hydroxy group present in the monomer (e.g., the hydroxy group present in HEMA) to produce an ether bond with the monomer. Thus, basic conditions should preferably be avoided.

The amount of reactive dye added to the reaction mixture will depend upon the particular dye used, and the depth of tint required. Generally, it may for example be in the range of from 0.01 to about 0.75, preferably from 0.05 to 0.5, wt % based on the weight of monomer.

In a preferred method of forming a contact lens, a lens-forming amount of a polymerisable mixture is dosed into a mould having the shape of the final contact lens once hydrated. The polymerisable mixture is then cured in the mould, for example by the application of ionising or actinic radiation as described above.

The following Examples illustrate the invention.

### EXAMPLE 1

### Synthesis of 1-amino-4-(methacryloyloxy)ethylamino-9,10-anthraquinone-2-sulphonic acid, sodium salt

To a 100 mL round bottom flask was added 0.90 g (5.45 mmol) of aminoethyl methacrylate hydrochloride salt and 30 mL of demineralised water. The salt was neutralised by the portion-wise addition of sodium bicarbonate (0.5 g). After complete neutralisation, 2.0 g (4.95 mmol) of bromaminic acid, 0.19 g (1.92 mmol) of cuprous chloride and 10 mL of ethanol were added. The reaction mixture was heated to 65° C. and 2.5 g (0.024 mol) of sodium carbonate was added in portions. The reaction mixture was then heated at 70° C. for 18 hours. The reaction mixture was allowed to cool to room temperature and then carefully poured into 5 mL of concentrated hydrochloric acid. The orange/red solid was isolated by filtration and washed with 1M HCl. The filter cone was transferred from the Buchner funnel to a vacuum oven and dried at 80° C., 10 mbar vacuum.

The product of this synthesis yielded 1.15 g of an orange powder which was analysed by IR and ¹H NMR and identified as 1-amino-4-(methacryloyloxy)ethylamino-9,10-anthraquinone-2-sulphonic acid, sodium salt.

### EXAMPLE 2

### Synthesis of 1-amino-4-(4-amino-2-sulfophenylamino)-9,10-anthraquinone-2-sulphonic acid, disodium salt

To a 1 litre round bottom flask were added 10.0 g (0.054 moles) of 2,5-diaminobenzene sulfonic acid, 6.7 g (0.063 moles) of sodium carbonate, 5.37 g (0.043 moles) of sodium sulfite and 500 mL of demineralised water. To the flask was then added 10.74 g (0.027 moles) of bromaminic acid sodium salt and 0.81 g (8.2 mmol) of cuprous chloride. The reaction was heated at 60° C. for 18 hours and then allowed to cool to room temperature. The reaction mixture was filtered and the filter cake was washed thoroughly with methanol. The solvent was removed on a rotary evaporator to give a brown solid. The solid was suspended in 250 mL of warm methanol and then filtered to remove any inorganic salts. The methanol was removed on the rotary evaporator and the resulting solid was dried in a vacuum oven at 80° C., 10 mbar vacuum. The product of this synthesis yielded 12.9 g of a dark green/brown solid which was analysed by IR and ¹H NMR and identified as 1-amino-4-(4-amino-2-sulfophenylamino)-9,10-anthraquinone-2-sulphonic acid, disodium salt.

### EXAMPLE 3

### Synthesis of 1-amino-4-(4-acryloylamido-2-sulfophenylamino)-9,10-anthraquinone-2-sulphonic acid, disodium salt

To a 100 mL round bottom flask was added 2.0 g (3.75 mmol) of the product obtained in example 2, 0.5 mL of 10N NaOH and 40 mL of demineralised water. The contents were mixed vigorously for 30 minutes at room temperature. To the flask was then added a solution of acryoyl chloride (0.43 g, 4.75 mmol) in acetone (2.5 mL) dropwise over 1 hour. The reaction mixture was stirred at room temperature for 3 hours. The pH of the reaction mixture was adjusted to pH 8 by dropwise addition of 0.1 M NaOH. The solvent was removed on a rotary evaporator to give a dark green solid. The solid was dissolved in MeOH and filtered to remove any inorganic salts. The MeOH was removed on a rotary evaporator. The residue was triturated with ice-cold diethyl ether, and the resulting solid was isolated by filtration. The filter cake was transferred from the Buchner funnel to a vacuum oven and dried at 80° C., 10 mbar vacuum. The product of this synthesis yielded 0.6 g of a dark green powder which was analysed by IR and ¹H NMR and identified as 1-amino, 4-(4-acryloylamido-2-sulfophenylamino)-9,10-anthraquinone-2-sulphonic acid, disodium salt.

### EXAMPLE 4

### Synthesis of 1-amino-4-(4-methacryloylamido-2-sulfophenyl-Amino)-9,10-anthraquinone-2-sulphonic acid, disodium salt

Example 3 was repeated, except that acryoyl chloride was replaced by an equimolar amount of methacryloyl chloride. The product of this synthesis yielded 1.3 g of a dark green powder which was analysed by IR and ¹H NMR and identified as 1-amino, 4-(4-methacryloylamido-2-sulfophenylamino)-9,10-anthraquinone-2-sulphonic acid, disodium salt.

### EXAMPLE 5

### Preparation of Tinted HEMA Based Contact Lenses

A homogeneous monomer blend was prepared with the composition as listed in Table 1. The drops of the monomer mixture were placed into contact lens moulds and then polymerised over a two hour period using a fluorescent UV light source (Radio Spares: Cat number 497-656).

TABLE 1

| | | |
|---|---|---|
| HEMA ULTRA | 98.44 | wt % |
| Pluronic F147 | 1.00 | wt % |
| Ethylene Glycol | 0.34 | wt % |
| Dimethacrylate | | |
| Benzoin methyl ether | 0.17 | wt % |
| Dyestuff | 500 | ppm |

The subsequent lenses made from the above formulation were swelled in a buffered saline solution. These were then tested for stability of colour by boiling in buffered saline solution and detecting for loss of dyestuff into the saline solution.

Dyestuff tested were those dyes synthesized from examples 1, 3, 4, and Reactive Blue 69. None of dyestuffs leached out into saline solution. The saline solution remained clear (water white).

### EXAMPLE 6

### Tinted Contact Lenses Comparison

Two filtered homogeneous monomer blends were prepared with the compositions as listed in Table 2. The drops of the monomer mixture were placed into contact lens moulds and then polymerised over a two hour period using a fluorescent UV light source (Radio Spares: Cat number 497-656).

TABLE 2

| | Lenses A | | Lenses B | |
|---|---|---|---|---|
| | With | | With | |
| | Reactive | | Reactive | |
| | Blue 69 | | Blue 4 | |
| HEMA ULTRA | 98.48 | wt % | 98.39 | wt % |
| Pluronic F147 | 1.00 | wt % | 1.00 | wt % |
| Ethylene Glycol | 0.34 | wt % | 0.34 | wt % |
| Dimethacrylate | | | | |
| Benzoin methyl ether | 0.17 | wt % | 0.17 | wt % |
| Dyestuff | 100 | ppm | 1000 | ppm |

The subsequent dry lenses made from the above formulation were compared and lenses A using 100 ppm of Reactive Blue 69 were equal in colour intensity by human eye observation to those made with 1000 ppm of Reactive Blue 4 (which is used in commercially-available contact lenses).

### EXAMPLE 7

### Preparation of Tinted GMMA Based Contact Lenses

Two different lens formulations were made using 2,3 dihydroxy propyl methacrylate (Glycerol mono methacrylate) as a major constituent as detailed in the table 3 below. The lenses were cured using the same procedure as described in example 5 and hydrated using commercially available saline to produce a stable hydrogel.

TABLE 3

| | Lens a | Lens b |
|---|---|---|
| Material | Composition | Composition |
| Glycerol | 91.9% | 32.8% |
| monomethacrylate | | |
| Hydroxyethyl | — | 65.63% |
| methacrylate | | |
| n- | 8.2% | — |
| methylpyrrolidone | | |
| Pluronic F-127 | — | 1.00% |
| Ethylene glycol | — | 0.34% |
| dimethacrylate | | |
| Benzoin methyl | 0.33% | 0.17% |
| ether | | |
| Reactive Blue 69 | 500 ppm | 500 ppm |

Both formulations retained the dye in the polymer without leaching out into the saline solution.

### EXAMPLE 8

### Preparation of Tinted High Water HEMA Based Contact Lenses

A high water formulation was made up using the formula detailed below in table 4. The lenses were cured as described in example 8 and hydrated using commercially available saline to produce a stable hydrogel.

TABLE 4

| Material | Composition |
|---|---|
| Hydroxyethyl methacrylate | 96.44% |
| Methacrylic acid | 2.00% |
| Pluronic F-127 | 1.00% |
| Ethylene glycol | 0.34% |
| dimethacrylate | |
| Benzoin methyl ether | 0.17% |
| Reactive Blue 69 | 500 ppm |

The formulation retained the dye in the polymer without leaching out into the saline solution.

### EXAMPLE 9

### Preparation of Tinted Silicone Hydrogel Based Contact Lenses

A silicone hydrogel formulation was made up using the formula detailed below in table 5. The lenses were cured as described in example 8 and hydrated using commercial available saline to produce a stable hydrogel.

TABLE 5

| Material | Composition |
|---|---|
| Dimethacrylamide | 39.21% |
| Tris (trimethyl | 55.32% |
| siloxy)silylpropyl | |
| methacrylate | |
| n-methyl pyrrolidone | 4.04% |
| Ethylene glycol | 1.01% |
| dimethacrylate | |
| Benzoin methyl ether | 0.41% |
| Reactive Blue 69 | 500 ppm |

The formulation retained the dye in the polymer without leaching out into the saline solution.

1-17. (canceled)

18. A process for the production of a tinted polymer, which comprises co-polymerizing a compound of formula (I) or a salt thereof, with at least one polymerizable monomer containing a vinyl group, formula (I) being: 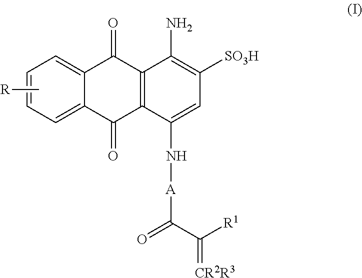
in which R is hydrogen or —SO₃H;
A is a direct bond, -alkylene-O—, -phenylene-NH— or -phenylene-NH-phenylene-NH—, wherein each phenylene ring independently may be optionally substituted with one or more of the same or different substituents selected from the group consisting of —SO₃H, —(CH₂)ₘSO₃H, —SO₂(CH₂)ₘSO₃H, —SO₂NH(CH₂)ₘSO₃H, —SO₂C₁₋₂alkyl, —SO₂C₁₋₂haloalkyl, —SO₂NHC₁₋₂alkyl, —SO₂NHC₁₋₂haloakyl, —C₁₋₂alkyl and C₁₋₂haloalkyl, wherein m is 1 or 2;
R¹ is hydrogen, halogen or C₁₋₄ alkyl; and
R² and R³ are independently hydrogen, C₁₋₄ alkyl or C₁₋₄ alkoxy;
with the proviso that, when R¹ is hydrogen or C₁₋₄ alkyl, and R is hydrogen, then A is -phenylene-NH— or -phenylene-NH-phenylene-NH—, wherein at least one phenylene ring is substituted with at least one sulfur-containing substituent.

19. The process of claim 18, wherein A is -alkylene-O—, optionally substituted -phenylene-NH-phenylene-NH—, or optionally substituted -phenylene-NH—.

20. A process of claim 19, wherein A is optionally substituted -phenylene-NH-phenylene-NH— or optionally substituted -phenylene-NH—, bearing at least one sulfur-containing substituent.

21. The process of claim 20, wherein A contains at least one —SO₃H group.

22. The process of claim 21, wherein A contains one —SO₃H group, and optionally, one or more methyl groups.

23. The process of claim 18, wherein the compound of formula (I) has the formula (Ia): 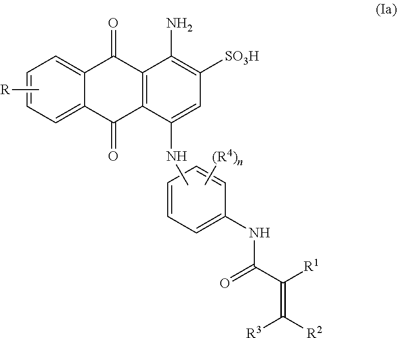
in which R⁴ is —SO₃H and n is 0, 1 or 2.

24. The process of claim 18, wherein R² and R³ are independently hydrogen or methyl.

25. The process of claim 18, wherein R¹ is halogen.

26. The process of claim 18, wherein said compound of formula (I) is a salt.

27. The process of claim 18, wherein said polymerizable monomer containing a vinyl group is selected from the group consisting of hydroxy esters of acrylic acid, hydroxy esters of methacrylic acid, hydroxy esters of itaconic acid, hydroxy esters of fumaric acid, hydroxy esters of maleic acid, N,N-dimethylacrylamide, N-vinyl pyrrolidone and styrene sulfonic acid.

28. The process of claim 27, wherein said polymerizable monomer comprises a hydroxy ester of acrylic acid or a hydroxy ester of methacrylic acid.

29. The process of claim 18, wherein said polymerizable monomer containing a vinyl group comprises a silicone hydrogel.

30. The tinted polymer product of the process of claim 18.

31. A medical device comprising the tinted polymer of claim 30.

32. A contact lens made from the tinted polymer of claim 30.
